(19) United States
(12) Patent Application Publication
(10) Pub. No.: US 2025/0008983 A1
(43) Pub. Date: Jan. 9, 2025

(54) COMPOSITIONS CONTAINING PEROXYACIDS TO CONTROL PATHOGEN GROWTH IN ANIMAL FEED AND RELATED METHODS

(71) Applicant: KEMIN INDUSTRIES, INC., DES MOINES, IA (US)

(72) Inventors: Jatuporn SALAKLANG, Clive, IA (US); Agnes Hwee Hong THNG, Hougang (SG); Shashank RAVI, Des Moines, IA (US); Haridasan CHIRAKKAL, Herentals (BE)

(73) Assignee: KEMIN INDUSTRIES, INC., DES MOINES, IA (US)

(21) Appl. No.: 18/766,645

(22) Filed: Jul. 8, 2024

Related U.S. Application Data
(60) Provisional application No. 63/525,315, filed on Jul. 6, 2023.

(51) Int. Cl. A23K 20/105; A01N 37/02; A01N 37/42; A01P 1/00; A23K 20/195

(52) U.S. Cl. CPC A23K 20/105; A01N 37/02; A01N 37/42; A01P 1/00; A23K 20/195

(57) ABSTRACT

The present invention relates to the use of compositions containing one or more peroxyacid to control the growth of pathogens, such as Salmonella, in animal feed. Another aspect of the present invention relates to a formaldehyde-free antimicrobial composition comprising one or more peroxyacid, where the composition is capable of controlling the growth of pathogens, such as Salmonella, in animal feed. Another aspect of the present invention relates to an animal feed additive comprising a buffered peroxyacid composition that is effective at controlling the growth of pathogens while preserving the nutrient content in the animal feed, where the buffered composition is less corrosive to steel and feed mill equipment than non-buffered compositions.

### CROSS-REFERENCE TO RELATED APPLICATIONS

The present application claims the benefit of priority to U.S. Patent Application No. 63/525,315, filed Jul. 6, 2023, entitled “COMPOSITIONS CONTAINING PEROXYACIDS TO CONTROL PATHOGEN GROWTH IN ANIMAL FEED AND RELATED METHODS,” the entire disclosure of which is incorporated herein by reference.

### BACKGROUND OF THE INVENTION

Formaldehyde has long been used in animal feed to control the spread of Salmonella. The use of formaldehyde in feed has raised concerns on safety and animal performance, however, and the use of formaldehyde is not approved for use in feed in certain regions such as the European Union. Due to the rising concerns associated with formaldehyde, there remains a need for suitable alternatives to formaldehyde that are capable of mitigating against the risk of Salmonella contamination in feed.

Peracetic acid, also known as peroxyacetic acid or PAA, has been used as a disinfectant in waste-water treatment (Baumeister, L. J., 2008) (Kitis, M., 2004), and food industries, (Stearns et al., 2022) due to its effectiveness against microbial contaminations.

Previous studies have reported the demonstrated effects of the combination of certain organic acids and ester. For instance, a study conducted by Higgins and Brinkhaus (1999) concluded that propionic acid is superior against common mold strains such as Aspergillus spp. and Fusarium spp. as compared to other organic acids such as acetic, sorbic, benzoic, undecylenic and lactic acids. Previous studies have also provided evidence on the effectiveness of medium chain fatty acids (MCFA) and its derivatives against common bacteria such as Salmonella spp., Escherichia coli, Staphylococcus aureus, Listeria monocytogenes and Campylobacter jejuni (Jackman et al., 2020), (Skrivanová et al., 2004), (Skrivanová et al., 2005), (Marounek et al., 2003), (Batovska et al., 2009). In addition, Cochrane et al. (2020) and Tran et al. (2021) demonstrated the efficacy of MCFA in mitigating porcine epidemic diarrhea (PED) and African swine fever (ASF) viruses, respectively.

Although various studies have been conducted with peroxyacids in other contexts, to the inventors' knowledge, the present invention represents the first time that compositions containing various peroxyacid combinations have been studied for controlling pathogen growth in animal feed and compared against peracetic acid and other common antimicrobial products that are commercially available as feed additives, such as Sal CURB RM E Liquid (Kemin Industries), Sal CURB K2 Liquid (Kemin Industries) and Sal CURB Ba Liquid (Kemin Industries), and a disinfectant, such as Pro-Oxine AH (Bio-Cide International).

### BRIEF SUMMARY OF THE INVENTION

The present invention relates to the use of compositions containing one or more peroxyacid to control the growth or spread of Salmonella in animal feed. The present invention further provides the benefit of providing anti-corrosive properties in comparison to other formulations used in the feed mill industry. Another aspect of the present invention relates to a formaldehyde-free antimicrobial composition suitable for animal feed that is capable of controlling the growth of Salmonella in animal feed. The compositions of the present invention show high efficacy in reducing Salmonella and other pathogens, e.g. viruses, mold, etc. even at high pH (i.e. >7-12).

### DETAILED DESCRIPTION OF THE DRAWINGS

FIG. 1 is a chart representing a preliminary in vitro efficacy study with peroxy acids against Salmonella.

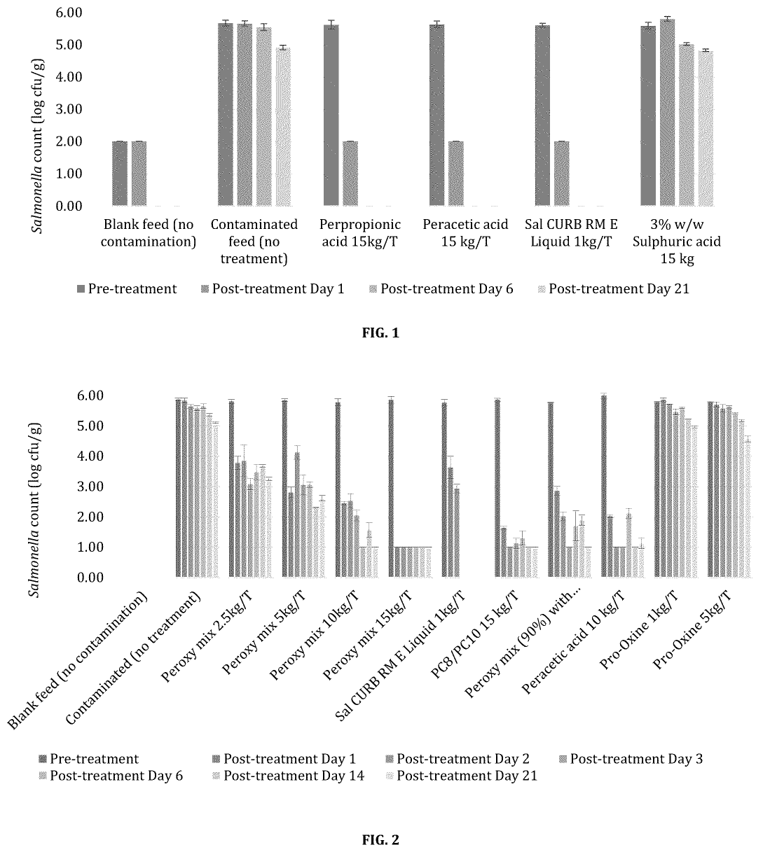

FIG. 2 is a chart representing Salmonella count at high contamination level (˜5 log cfu/g), over 21 days post treatment period.

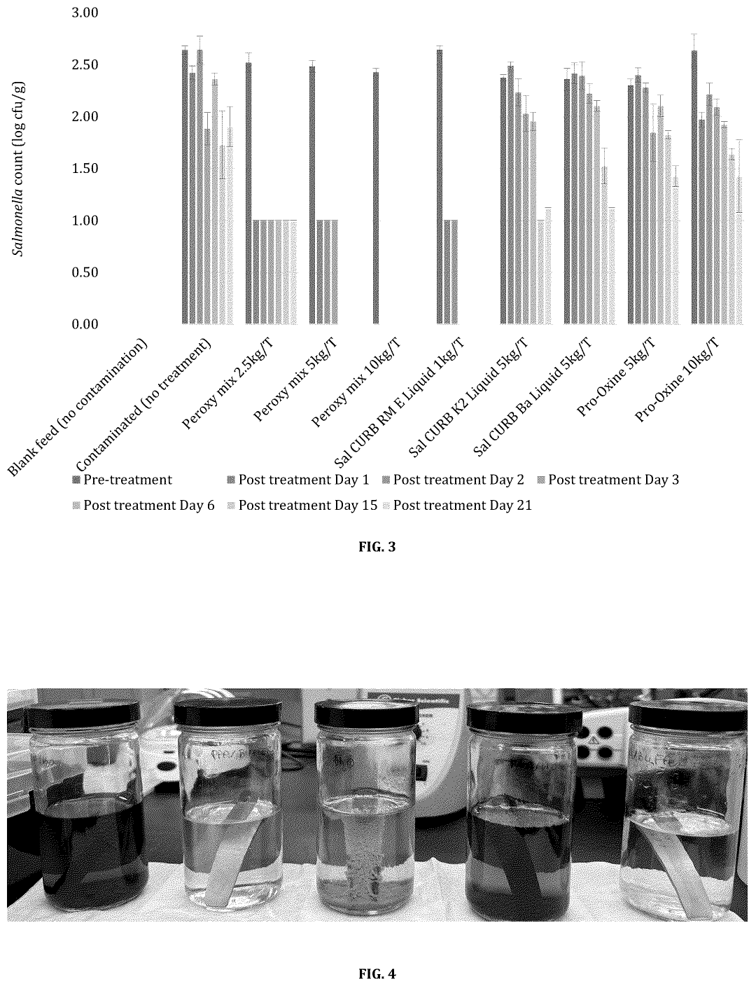

FIG. 3 is a chart representing Salmonella count at low contamination level (˜2 log cfu/g), over 21 days post-treatment period.

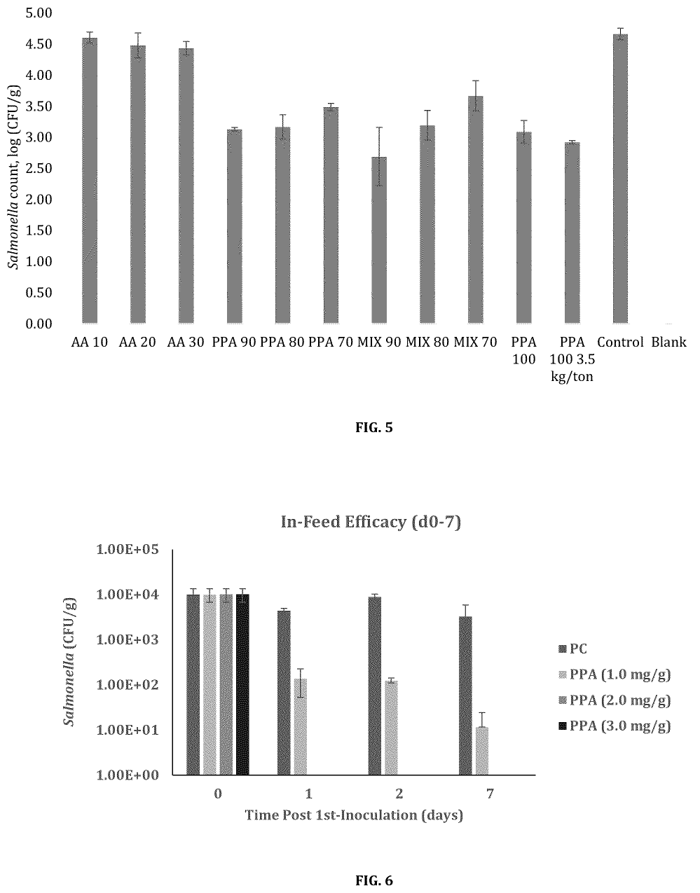

FIG. 4 depicts mild steel when dipped into solution containing 1) 24 g PPA +96 g water and 2) 24 g PPA +96 g Sodium mono, di, tri-phosphate buffer, 3) 120 g water, 4) 24 g PAA +96 g water and 5) 24 g PAA +96 g Sodium mono, di, tri-phosphate buffer. Solutions denoting 2 kg/ton PPA dosage/ton feed.

FIG. 5 depicts the efficacy of PPA mixtures in combination with acetic acid towards Salmonella in the feed matrix.

FIG. 6 depicts Salmonella counts (CFU/g) 1, 2, and 7 days post inoculation from the control and 1.0, 2.0, and 3.0 mg PPA/g feed samples. Feed was inoculated with 1E04 CFU/g feed. Bars represent the mean±standard deviation. PC=positive control, untreated and inoculated feed.

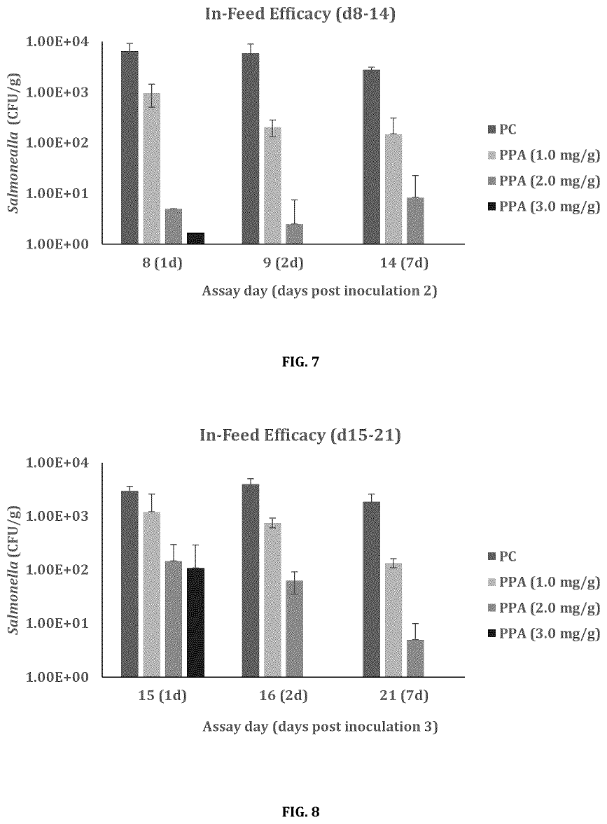

FIG. 7 depicts Salmonella counts (CFU/g) 1, 2, and 7 days post inoculation two (days 8, 9, and 14 of the assay) from control and 1.0, 2.0, and 3.0 mg PPA/g feed samples. Feed was inoculated a second time on day 7 with 1 g of 1E6 CFU/g Salmonella dry inoculum (1E4 CFU/g feed). Bars represent the mean±standard deviation. PC=positive control, untreated and inoculated feed.

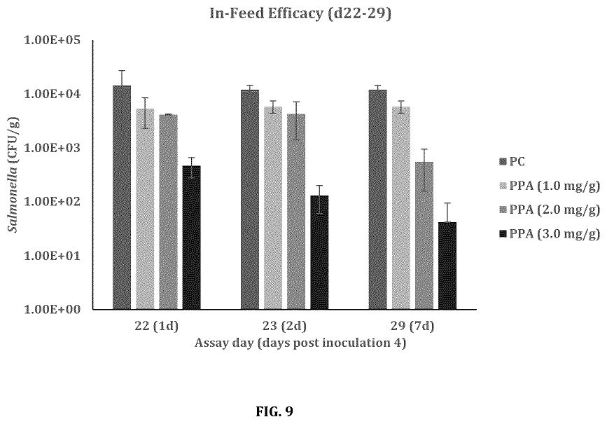

FIG. 8 Salmonella counts (CFU/g) 1, 2, and 7 days post inoculation three (days 15, 16, and 21 of the assay) from control and 1.0, 2.0, and 3.0 mg PPA/g feed samples. Feed was inoculated a third time on day 14 with 1 g of 1E6 CFU/g Salmonella dry inoculum (˜1E4 CFU/g feed). Bars represent the mean±standard deviation. PC=positive control, untreated and inoculated feed.

FIG. 9 depicts Salmonella counts (CFU/g) 1, 2, and 7 days post inoculation three (days 22, 23, and 29 of the assay) from control and 1.0, 2.0, and 3.0 mg PPA/g feed samples. Feed was inoculated a fourth time on day 21 with 1 g of 1E6 CFU/g Salmonella dry inoculum (˜1E4 CFU/g feed). Bars represent the mean±standard deviation. PC=positive control, untreated and inoculated feed

### DETAILED DESCRIPTION OF THE INVENTION

The present invention relates to the use of compositions containing one or more peroxyacid to control the growth or spread of Salmonella in animal feed. Another aspect of the present invention relates to a formaldehyde-free antimicrobial composition suitable for animal feed that is capable of controlling the growth or spread of Salmonella in animal feed.

Prevention of Salmonella or its decontamination is one of the major challenges in feed industry. Currently, formaldehyde is the only approved feed additive for Salmonella decontamination in North America, but it is banned in European Union (EU) as a potential carcinogen.

Peroxy acids are strong oxidizing agents that have been used as disinfecting agents in meat industries and surface cleaning applications of medical instruments due to its ability to denature proteins and disrupt the cell wall membrane of microorganisms. However, peroxy acids have never been explored for the feed treatment applications in the past. One possible reason could be that these peroxy acids react violently when in contact with mild steel or carbon steel, which is predominantly the material of construction of mixer units in feed mills. These industrial mixers are used for blending various micro and macro feed components. It has been understood that spraying a peroxy product onto the feed ingredients that will come into contact with the mixers in a feed mill, for instance while the mixer is in operation, would pose a serious corrosion risk to the equipment, as well as leading to potential contamination.

According to at least one embodiment, the present invention is a mitigation measure to control and/or to prevent the proliferation of Salmonella in animal feed using a composition that contains one or more peroxy acid, including but not limited to peroxyacids selected from the group consisting of C1-C10 alkyl chains. According to at least one embodiment, the composition contains peroxyacids selected from the group consisting of C2, C3, C8 and/or C10 alkyl chains. According to certain embodiments the one or more peroxyacid is in combination with one or more organic acids or carboxylic acids of C2-C10, and/or esters, including but not limited to propylene glycol propionate esters.

According to at least one embodiment, the one or more peroxyacid of the present invention is perpropionic acid. According to at least one embodiment, the one or more peroxyacid is peracetic acid.

According to at least one embodiment, the composition contains two or more peroxyacids, such as perpropionic and peracetic acids. In at least one embodiment the perpropionic and peracetic acids are present in the composition in a 1:1 ratio. In alternative embodiments, the composition contains two or more peroxyacids in a ratio from about 2:1 to 1:2, 3:1 to 1:3, 4:1 to 1:4, or 5:1 to 1:5.

According to at least one embodiment, the composition contains two or more peroxyacids, such as peroctanoic acid (PC8) and perdecanoic acid (PC10). In at least one embodiment the peroctanoic acid and perdecanoic acid are present in the composition in a 1:1 ratio. In alternative embodiments, the composition contains two or more peroxyacids in a ratio from about 2:1 to 1:2, 3:1 to 1:3, 4:1 to 1:4, or 5:1 to 1:5.

In alternative embodiments, the composition may comprise one or more esters, for instance, propylene glycol propionate esters.

According to at least one embodiment, the composition of the present invention is added to animal feed at a dosage of between about 0.1 kg/ton to 20 kg/ton, such as 2.5 kg/ton to 20 kg/ton. According to at least one embodiment, the composition is added to animal feed at a dosage of about 0.1 kg/ton to 20 kg/ton, such as 2.5 kg/ton to 15 kg/ton, for instance about 5 kg/ton, to 15 kg/ton.

According to at least one embodiment, the composition of the present invention is capable of reducing the Salmonella count to an undetectable level (<1 log cfu/g) within 24 hours of application.

According to at least one embodiment, the feed additive or antimicrobial composition is a buffered solution. For instance, in certain embodiments the composition is a liquid solution with an initial pH within the range of 2 to 5, for instance pH 4, that has been neutralized with a phosphate buffer to adjust the pH of the solution to about pH 7 to 8, and/or about pH 8 to 12. In at least one embodiment, the feed additive is a buffered peroxyacid composition that is effective at a pH ranging from about 1 to 12, specifically about 1 to 6, about 7 to 8, about 8 to 10, or about 11 to 12.

According to at least one embodiment, the buffered peroxyacid contains a sodium phosphate buffer. In alternative embodiments the buffer is ammonium hydroxide or sodium hydroxide. In certain embodiments, the buffered peroxyacid composition contains mono, di, sodium phosphate, and or trisodium phosphate, ammonium phosphate, sodium hydroxide, or ammonium hydroxide.

In certain embodiments, the compositions of the present invention possess anti-corrosive properties in comparison to peroxyacid alone or commercially available products. In certain embodiments, the compositions of the present invention do not contain formaldehyde (i.e. formaldehyde-free) but are capable of providing similar or equivalent antimicrobial activity to commercially available products that contain formaldehyde.

In certain embodiments, the composition of the present invention is suitable for animal feed applications and capable of controlling the growth of Salmonella in animal feed. The compositions of the present invention show high efficacy in reducing Salmonella and other pathogens, e.g. viruses, mold, etc. even at high pH (i.e. >7-12).

According to at least one embodiment, the compositions of the present invention are suitable as an additive in animal feed and can be combined with known animal feed ingredients, including but not limited to corn meal, soybean meal, fish meal, soy oil cake, dried distillers' grains with solubles (DDGS), etc.

For purposes of this disclosure, “animal feed” may be provided to the animals through any convention means well known to persons skilled in the art, include but not limited to top-dress, mixed in by hand, pelleted, mixed with crumbles, etc.

### EXAMPLES

### Example 1—In Vitro Efficacy of Different Peroxy Acid Mixtures Against Salmonella—in Comparison to Salmonella Mitigating Products

Preparation of the treatment. The details of each treatment were tabulated in Table 1. Perpropionic acid, peracetic acid, mixture of peroctanoic acid and perdecanoic acid (PC8/PC10) and Sal CURB products were used without any further dilution or mixing. The peroxy mix was prepared by mixing peracetic and perpropionic acid in 1:1 weight ratio. Briefly, 1.0 g of peroxy mix was prepared by weighing 0.5 g of peracetic acid into 0.5 g of perpropionic acid. The mixture was mixed well prior to usage. Similar procedure was followed in the preparation of 3% sulphuric acid (where 0.03 g of sulphuric acid was added into 99.97 g of water) and peroxy mix with ester (where 0.9 g of peroxy mix (prepared with peracetic and propionic acid) was mixed with 0.1 g of propylene glycol propionate esters). Pro-Oxine AH was activated as per recommended. Briefly, 1 mL of 75% phosphoric acid was added to 10 mL of Pro-Oxine solution and mixed well. The mixture is covered and let to stand for 10 mins prior to usage.

TABLE 1
Treatment details

| | | Dosage |
|---|---|---|
| | | tested |
| Sample | Composition/RM code | (kg/ton) |
| Perpropionic | 17.1% wt. perpropionic acid and 7.8% wt.hydrogen | 15.0 |
| acid | peroxide, ~45% propionic acid, 1% wt. H₂SO₄ and | |
| | water | |
| Peracetic acid | 17.5% wt. peracetic acid and 9.8% wt.hydrogen | 10.0-15.0 |
| | peroxide, ~43% Acetic acid, 1% wt. H₂SO₄ and water | |
| 3% wt. sulphuric | Sulphuric acid 3% wt./ | 15.0 |
| acid/H₂SO₄ | | |
| Peroxy mix | Peracetic and perpropionic acids in 1:1 (w/w) ratio | 2.5-15.0 |
| PC8/P10 | 10% wt. Peroctanoic and 10% wt.perdecanoic acids | 15.0 |
| | in 1:1 (w/w) ratio | |
| Peroxy mix with | 90% wt.) peroxy mix and 10% wt. propylene glycol | 10.0 |
| ester | propionate esters | |
| Pro-Oxine AH | 8.35% wt. sodium chlorite (5% chlorine dioxide); | 5.0-10.0 |
| (contain ClO₂ as | activated as per recommended | |
| an oxidizing | | |
| agent) | | |
| Sal CURB Ba | 49% wt. formic, 10% wt. propionic and 7% wt. lactic | 5.0 |
| Liquid (non- | acids with surfactants/ | |
| formaldehyde) | | |
| Sal CURB K2 | 50% wt. formic, 9% wt. propionic and 7% wt. lactic | 5.0 |
| Liquid (non- | acids | |
| formaldehyde) | | |
| Sal CURB RM E | 33% wt. formaldehyde and 13% wt. propionic acid | 1.0 |
| Liquid | | |
| (formaldehyde | | |
| product) | | |

*pH of all liquid samples was below pH 4

Preparation of stock feed inoculum. The researchers prepared contaminated feed from known methods, where Salmonella enterica isolated from layer feed was revived from the glycerol stock by plating a loopful of culture onto the TSAYE (i.e., tryptone soya agar supplemented with 0.6% yeast extract (CM0131B; Oxoid) prepared as per recommended) and incubate for 18-24 hours at 37° C. Following which, the colonies were collected aseptically with saline solution (i.e., 0.9% sodium chloride (V800372; Sigma-Aldrich) prepared in deionized water), yielding approximately 5 mL of biomass suspension. The biomass suspension was diluted accordingly to meet the contamination level required for the stock inoculum. No dilution was required for high contamination level of ca. 10⁷ cfu/g whereas biomass suspension was diluted 1000 times to achieve lower contamination level of ca. 10⁴ cfu/g in the stock inoculum. The stock feed inoculum was prepared by adding the biomass suspension (5 mL) into 100 g of sterile feed (made up with 7:3 ground corn and soybean, autoclaved at 121° C. for one hour and dried for 24 hours at 65° C.) with a syringe and needle, and homogenously mixed after. The stock feed inoculum was stored at 25° C. for a week. Salmonella count of the stock inoculum was determined using conventional plating method with XLD agar (i.e., Xylose lysine deoxycholate (CM0469B; Oxoid)) and BPW (i.e., buffered peptone water (CM0509B; Oxoid)) prior to usage. Briefly, three grams of stock feed inoculum was weighed into a 50 mL conical tube, diluted with 27 mL of BPW, homogenously mixed and left to stand for 30 minutes. The feed suspension was then serial diluted to the appropriate dilutions. An aliquot of 0.1 mL of the feed suspension was plated onto the agar at each dilution and incubated at 37° C. for 18-24 hours prior to enumeration. Plating was carried out in triplicates. Blank stock feed was prepared by adding 5 mL of saline into 100 g of sterile feed.

Preparation of the feed inoculum. The stock feed inoculum was diluted approximately 100 times with sterile feed where three grams of stock inoculum was added into 307 g of sterile feed and kept at 37° C. for 24 hours. The Salmonella count of the feed was determined prior to treatment. Briefly, 90 mL of BPW was added into 10 g of feed sample in a sterile bag (10⁻¹ dilution). The mixture was homogenously mixed with a stomacher at medium speed for three minutes and left to stand for 30 minutes. The feed supernatant was serial diluted to appropriate dilutions for plating. The plates were incubated at 37° C. for 18-24 hours prior to counting. If low Salmonella count was expected, the sample size was increased to 1 mL by plating 300, 300 and 400 uL onto three plates in triplicates for higher detection limit (10 cfu/g). Blank feed was prepared by adding three grams of blank stock feed into 307 g of sterile feed. In addition, an extra contaminated feed was prepared as a control.

Treatment of contaminated feed. The contaminated feed (300 g) was then treated with the different treatments summarized in Table 7. The product/prototype was accurately weighed at the needed dosage and adjusted to a total volume of 5 mL prior to adding into the 300 g of contaminated working feed with a syringe and needle. Product/prototype was added in batches (i.e., 2, 2, and 1 mL separately) with mixing after each addition. Five mL of sterile water was added into the extra contaminated feed and blank feed as controls. The treated feed samples were homogenized after treatment and kept at 37° C. for 24 hours prior to enumeration. Enumeration was carried out as detailed in above section. In addition, the diluted feed samples (at 10⁻¹ dilution factor) was subsequently kept at 37° C. for 18-24 hours for enrichment prior to streaking. A loopful of diluted feed suspension was streaked onto the XLD agar and incubated at 37° C. for 18-24 hours to determine qualitatively the presence of Salmonella for samples with undetectable Salmonella count.

Hydrogen peroxide and peroxy acid contents in peracetic and perpropionic acids. Peroxy acid contents in both peracetic and perpropionic acids were comparable (Table 2). Hydrogen peroxide content of peracetic and perpropionic acids were 9.8% and 7.8% respectively.

TABLE 2
Hydrogen peroxide and peroxy contents
of peracetic and perpropionic acids

| | Hydrogen peroxide | Peroxy content |
|---|---|---|
| Sample | content (% wt.) | (% wt.) |
| Peracetic acid | 9.8 | 17.5 |
| Perpropionic | 7.8 | 17.1 |
| acid | | |

Initial efficacy test. The preliminary in vitro feed assay was conducted with the individual peroxy-acids in comparison to Sal CURB RM E Liquid and 3% w/w sulphuric acid. Concentrated sulphuric acid was used as the acid catalyst in synthesizing the peroxy acid and thus it was tested in the preliminary study to determine if sulphuric acid could have contributed to the Salmonella killing effect. No Salmonella killing effect was observed with sulphuric acid over the 21 days (Table 3, FIG. 1). On the other hand, perpropionic and peracetic acids demonstrated strong Salmonella killing effect at 15 kg/ton, where the Salmonella count was reduced to an undetectable level (<2.0 log cfu/g) within 24 hours, showing similar trends in comparison to 1 kg/ton of Sal CURB RM E Liquid. No Salmonella was recovered upon overnight enrichment in all treatments, except with sulphuric acid, by Day 6. This indicates a complete Salmonella elimination after six post treatment days.

TABLE 3
Preliminary trial with peroxy acids against Salmonella
count, over 21 days post-treatment period

| | | Salmonella count (log cfu/g) | | | |
|---|---|---|---|---|---|
| | | Pre- | | | |
| | Dosage | treatment | Post-treatment | | |
| Day | (kg/ton) | Day 0* | Day 1* | Day 6 | Day 21 |
| Blank feed | — | BD | BD | ND | ND |
| (No contamination) | | | | | |
| Contaminated feed | — | 5.67 | 5.66 | 5.54 | 4.91 |
| (No treatment) | | | | | |
| Perpropionic acid | 15 | 5.62 | BD | ND | ND |
| Peracetic acid | 15 | 5.63 | BD | ND | ND |
| Sal CURB RM E | 1 | 5.60 | BD | ND | ND |
| Liquid | | | | | |
| 3% w/w sulphuric | 15 | 5.59 | 5.80 | 5.02 | 4.82 |
| acid | | | | | |

Note:
ND = No salmonella detection upon enrichment;
BD = Salmonella count is below detection limit (2 log cfu/g);
Sal CURB RM E (formaldehyde product);
Sal CURB K2, Ba (non-formaldehyde product, contains organic acids);
Pro-Oxine AH (non-formaldehyde product, contains chlorine dioxide, an oxidizing agent).

Studies using high Salmonella count (10⁵ cfu/g) feed. Consistent to the preliminary results, effective Salmonella reduction was observed with the different peroxy acid treatments z,999 (Table 10). A dose dependent effect was observed with peroxy mix (1:1 perpropionic acid: peracetic acid). At least 2.0 log cfu/g of Salmonella reduction was observed with 2.5-10.0 kg/ton of peroxy mix after 24 hours (Table 4, FIG. 2). With higher dose of peroxy mix at 15.0 kg/ton, at least 4.8 log cfu/g of Salmonella reduction was observed after 24 hours. Similar trend was observed with other peroxy acid treatments where at least 4.2 log cfu/g Salmonella reduction was observed PC8/PC10 (1:1 perdecanoic:peroctanoic acid mixture) at 15.0 kg/ton and an approximately 3.0-4.0 log cfu/g Salmonella reduction was observed with peroxy mix with propylene glycol ester, and with peracetic acid at 10.0 kg/ton. No complete elimination of Salmonella was observed with these treatments. In contrast, with 1.0 kg/ton of Sal CURB RM E Liquid, at least 4.7 log cfu/g of Salmonella reduction was observed (Day 3) and complete Salmonella elimination was observed (Day 6).

TABLE 4
Salmonella count at high contamination level (~5 log
cfu/g), over 21 days post-treatment period

| | | Salmonella count (log cfu/g) | | | | | | |
|---|---|---|---|---|---|---|---|---|
| | | Pre- | | | | | | |
| | | treatment | | | | | | |
| | Dosage | Day | Post-treatment Day | | | | | |
| Sample | (kg/ton) | 0 | 1 | 2 | 3 | 6 | 14 | 21 |
| Blank feed (No | — | ND | ND | ND | ND | ND | ND | ND |
| contamination) | | | | | | | | |
| Contaminated | — | 5.87 | 5.83 | 5.64 | 5.58 | 5.64 | 5.37 | 5.11 |
| (No treatment) | | | | | | | | |
| Peroxy Mix^{a} | 2.5 | 5.80 | 3.78 | 3.84 | 3.08 | 3.47 | 3.68 | 3.25 |
| Peroxy Mix | 5.0 | 5.84 | 2.80 | 4.12 | 3.05 | 3.06 | 2.31 | 2.61 |
| Peroxy Mix | 10.0 | 5.77 | 2.45 | 2.52 | 2.04 | BD | 1.56 | BD |
| Peroxy Mix | 15.0 | 5.85 | BD | BD | BD | BD | BD | BD |
| Sal CURB | 1.0 | 5.76 | 3.63 | 2.93 | BD | ND | ND | ND |
| RM E Liquid | | | | | | | | |
| PC8/PC10^{b} | 15.0 | 5.86 | 1.64 | BD | 1.12 | 1.30 | BD | BD |
| Peroxy mix (90%) | 10.0 | 5.76 | 2.85 | 2.01 | BD | 1.70 | 1.88 | BD |
| with propylene | | | | | | | | |
| glycol propionate | 10.0 | 5.98 | 2.01 | BD | BD | 2.11 | BD | 1.12 |
| ester (10%) | | | | | | | | |
| Peracetic acid | | | | | | | | |

Note:
ND = No Salmonella detection upon enrichment; BD = Salmonella count is below detection limit (1 log cfu/g).
^{a}Peroxy mix contains peracetic and perpropionic acids in 1:1 (w/w) ratio.
^{b}PC8/PC10 contains peroctanoic and perdecanoic acids in approximately 1:1 (w/w) ratio.
Sal CURB RM E (formaldehyde product); Sal CURB K2, Ba (non-formaldehyde product, contains organic acids); Pro-Oxine AH (non-formaldehyde product, contains chlorine dioxide, an oxidizing agent).

Studies using low Salmonella count (10² cfu/g) feed. Peroxy mix (1:1 perpropionic acid:peracetic acid) at the three tested dosages (2.5, 5.0 and 10.0 kg/ton) were able to reduce the Salmonella count to undetectable level (<1 log cfu/g) within 24 hours (Table 5, FIG. 3). Salmonella [symbol] elimination could be achieved with 5.0 and 10.0 kg/ton of peroxy acid mix after six and one post-treatment day(s), respectively. In comparison to the organic acid-based Sal CURB products such as Sal CURB K2 Liquid and Sal CURB Ba Liquid, no Salmonella reduction (log reduction) was observed as compared to the control. Similar trend was observed with Pro-Oxine™ AH (acid activated).

TABLE 5
Salmonella count at low contamination level (~2 log
cfu/g), over 21 days post treatment period

| | | Salmonella count (log cfu/g) | | | | | | |
|---|---|---|---|---|---|---|---|---|
| | | Pre- | | | | | | |
| | | treatment | | | | | | |
| | Dosage | Day | Post-treatment Day | | | | | |
| Sample | (kg/ton) | 0 | 1 | 2 | 3 | 6 | 15 | 21 |
| Blank feed | — | ND | ND | ND | ND | ND | ND | ND |
| (No contamination) | | | | | | | | |
| Contaminated feed | — | 2.64 | 2.42 | 2.64 | 1.88 | 2.36 | 1.73 | 1.90 |
| (No treatment) | | | | | | | | |
| Peroxy Mix* | 2.5 | 2.52 | BD | BD | BD | BD | BD | BD |
| Peroxy Mix | 5.0 | 2.48 | BD | BD | BD | ND | ND | ND |
| Peroxy Mix | 10.0 | 2.43 | ND | ND | ND | ND | ND | ND |
| Sal CURB RM E Liquid | 1.0 | 2.64 | BD | BD | ND | ND | ND | ND |
| Sal CURB K2 Liquid | 5.0 | 2.37 | 2.49 | 2.23 | 2.03 | 1.95 | 1.00 | 1.12 |
| Sal CURB Ba Liquid | 5.0 | 2.36 | 2.41 | 2.39 | 2.22 | 2.10 | 1.52 | 1.12 |
| Pro-Oxine AH | 5.0 | 2.30 | 2.40 | 2.28 | 1.85 | 2.10 | 1.82 | 1.43 |
| Pro-Oxine AH | 10.0 | 2.63 | 1.97 | 2.21 | 2.09 | 1.92 | 1.64 | 1.43 |

Note:
ND = No Salmonella detection upon enrichment; BD = Salmonella count is below detection limit (1 log cfu/g).
^{a} Peroxy mix contains peracetic and perpropionic acids in 1:1 (w/w) ratio; Sal CURB RM E (formaldehyde product); Sal CURB K2, Ba (non-formaldehyde product, contains organic acids); Pro-Oxine AH (non-formaldehyde product, contains chlorine dioxide, an oxidizing agent).

Discussion. The researchers compared the efficacy of peroxy acids (peracetic, perpropionic, peroctanoic and perdecanoic acids) at different combinations, dosages, and contamination levels against other key existing Salmonella mitigants and disinfectant such as Sal [symbol] CURB RM E Liquid (formaldehyde with organic acid product), Sal CURB K2 Liquid (non-formaldehyde, organic acids), Sal CURB Ba Liquid (non-formaldehyde, organic acids) and Pro-Oxine AH (ClO2, an oxidizing agent). A preliminary trial conducted with the individual peroxy acids at 15.0 kg/ton shows effective Salmonella killing effect.

With the positive results, more extensive in-vitro efficacy feed assays were carried out at two Salmonella contamination levels (10² and 10⁵ cfu/g). Additionally, different alkyl chains (-C2, C3, C8 and C10) of peroxy acids and with propylene glycol propionate esters, were also explored. They are namely peroxy mix (containing both perpropionic and peracetic acids), PC8/PC10 (containing both peroctanoic and perdecanoic acids) and lastly peroxy mix with propylene glycol propionate esters. Dose dependent effect was observed with peroxy mix where peroxy mix could reduce up to 2.0-4.8 log cfu/g of Salmonella at 2.5-15.0 kg/ton. The different peroxy acid and combinations demonstrated comparable Salmonella killing effects at the same dosages. Additionally, peroxy mix outperformed the organic acid-based products such as Sal CURB K2 Liquid and Sal CURB Ba Liquid, and Pro-Oxine AH (Table 5). Antimicrobial effects of organic acids are pH dependent where organic acids enter the bacterial cell in their undissociated form and dissociate within the cells. Such dissociation decreases the pH within the cells and causes a cascade of cellular activities, resulting in cell death. Similar mode of action is expected with peroxy acids when they are broken down into their starting materials. However, peroxy acid, being an oxidizing agent, could also disrupt the structural proteins and interrupt enzymatic reactions by reacting with sulfhydryl and sulphur bonds present, giving it an edge over organic acids. On the other hand, the high reactivity of acidified sodium chlorite and/or chlorine dioxide accounted for its poor efficacy in feed. In comparison to 1.0 kg/ton of Sal CURB RM E Liquid, comparable Salmonella reduction was observed with 2.5 kg/ton where both treatments could reduce up to 2.0 log cfu/g of Salmonella after 24 hours. Complete elimination of 2.5 log cfu/g of Salmonella could be achieved with 5.0 and 10.0 kg/ton of peroxy mix after six and one post-treatment days, respectively.

### Example 2: Time Kill Effect of Peroxy Acids in Feed Model

Materials and Methods. The Salmonella enterica isolated from layer feed was revived from the glycerol stock by plating a loopful of culture onto the TSAYE (i.e., tryptone soya agar supplemented with 0.6% yeast extract (CM0131B; Oxoid) prepared as per recommended) and incubate for 18-24 hours at 37° C. Following which, the colonies were collected aseptically with saline solution (i.e., 0.9% sodium chloride (V800372; Sigma-Aldrich) prepared in deionized water), yielding approximately 5 mL of biomass suspension. The biomass suspension was diluted accordingly to meet the contamination level required for the stock inoculum. The stock feed inoculum was prepared by adding the biomass suspension (5 mL) into 100 g of sterile feed (made up with 7:3 ground corn and soybean, autoclaved at 121° C. for one hour and dried for 24 hours at 65° C.) with a syringe and needle, and homogenously mixed after. The stock feed inoculum was then kept in at 25° C. for a week. Salmonella count of the stock inoculum was determined using conventional plating method with XLD agar (i.e., Xylose lysine deoxycholate (CM0469B; Oxoid) and BPW (i.e., buffered peptone water (CM0509B; Oxoid)) prior to usage. Briefly, three grams of stock feed inoculum is weighed into a 50 mL conical tube, diluted with 27 mL of BPW, homogenously mixed and left to stand for 30 minutes. The feed suspension was then serial diluted to the appropriate dilutions. An aliquot of 0.1 mL of the feed suspension was plated onto the agar at each dilution and incubated at 37° C. for 18-24 hours prior to enumeration. Plating was carried out in triplicates. Blank stock feed was prepared by adding 5 mL of saline into 100 g of sterile feed.

The contaminated working feed is prepared by diluting the stock feed inoculum prepared in above section by approximately 100 times with sterile feed where three grams of stock inoculum is added into 307 g of sterile feed and kept at 25° C. for 24 hours. The Salmonella count of the feed was determined prior to treatment. Briefly, 90 mL of BPW was added to 10 g of feed sample in a sterile bag (10⁻¹ dilution). The mixture was homogenously mixed with a stomacher at medium speed for three minutes and left to stand for 30 minutes. The feed supernatant was serial diluted to appropriate dilutions for plating. The plates were incubated at 37° C. for 18-24 hours prior to counting and treatment. Blank feed was prepared by adding three grams of blank stock feed into 307 g of sterile feed. In addition, an extra contaminated feed was prepared as a control.

The contaminated working feed (300 g) was then treated with the different treatments as tabulated in shown in Table 6. The product/prototype was accurately weighed at the needed dosage and adjusted to a total volume of 5 mL prior to adding into the 300 g of contaminated working feed with a syringe and needle. Product/prototype was added in batches (i.e., 2, 2, and 1 mL separately) with mixing after each addition. Five mL of sterile water was added into the extra contaminated feed and blank feed as controls. The treated feed samples were homogenized after treatment and kept at 25° C. for 24 hours prior to enumeration at time intervals of 1, 3, 5, 10 and 24 hours. The effect of peroxy acids and Sal CURB RM E Liquid was neutralized at each interval prior to enumeration. Briefly, 20 mL of 0.1M sodium thiosulphate was added into 10 g of each treated feed sample in a sterile bag. The mixture was mixed well and left to stand for 10 minutes. After 10 minutes, 70 mL of BPW was added to achieve 10⁻¹ dilution. The feed suspension was further serial diluted to appropriate dilutions for enumeration. Enumeration was carried out as detailed above. If low Salmonella count is expected, the sample size is increased to 1 mL by plating 300, 300 and 400 uL onto three plates in triplicates for lower detection limit (10 CFU/g). In addition, the diluted feed samples (at 10⁻¹ dilution factor) was subsequently kept at 37° C. for 18-24 hours for enrichment prior to streaking. A loopful of diluted feed suspension was streaked onto the XLD agar and incubated at 37° C. for 18-24 hours to determine qualitatively the presence of Salmonella for samples with undetectable Salmonella count.

Results. Preliminary time kill effect of peroxy acids mixture (in 1:1 w/w peracetic and perpropionic acids) was evaluated in comparison to Sal CURB RM E Liquid (M804403). Results showed that at 15 kg/ton, peroxy acid mixture could reduce at least 2.8 log CFU/g of Salmonella within an hour and completely eliminate the Salmonella within three hours (Table 6). In comparison, a lower dosage of peroxy acid mixture (at 2.5 kg/ton) could reduce up to 1.8 log CFU/g of Salmonella within 3 hours. On the other hand, Sal CURB RM E Liquid (at 1 kg/ton) demonstrated slower Salmonella killing effect where only 0.6 log CFU/g of Salmonella reduction was observed up to 5 hours post-treatment, and no complete elimination was observed after 24 hours. The preliminary results demonstrated the fast-killing effect of peroxy acids (peracetic and perpropionic acid) and imply that a short treatment time of 1-3 hours is feasible with a low contamination level (of less than 2 log CFU/g). Further studies would focus on different contamination levels, enumeration with a larger sample size for a lower detection limit (10 CFU/g) for peroxy acid mixture at 2.5 kg/ton at 3-, 5-, and 10-hour time points.

TABLE 6
Salmonella count reduction after 24 hours treatment

| | Pre- | 1 | 3 | 5 | 10 | 24 |
|---|---|---|---|---|---|---|
| Sample Description | treatment | hour | hours | hours | hours | hours |
| Blank (No contamination | ND | ND | ND | ND | ND | ND |
| and treatment) | | | | | | |
| Control (No treatment) | 3.70 | 3.97 | 3.90 | 3.90 | 3.78 | 3.76 |
| Sal CURB RM E Liquid | 3.56 | 3.16 | 3.15 | 3.01 | 2.70 | 1.37 |
| (1 kg/ton) | | | | | | |
| Peroxy acid mixture* | 3.78 | 2.12 | <2.00 | <2.00 | 2.00 | <1.00 |
| (2.5 kg/ton) | | | | | | |
| Peroxy acid mixture* | 3.82 | <1.00 | ND | ND | ND | ND |
| (15 kg/ton) | | | | | | |

*Peroxy acid mixture is prepared with 1:1 w/w of peracetic and perpropionic acids.
ND = Salmonella not detected after enrichment for 18-24 hours.

### Example 3: Minimum Inhibitory Concentration (MIC) of Peroxy Acids, Peracetic Acid and Perpropionic Acid Against Escherichia coli ATCC 25922

Materials and Methods. The assay was conducted to determine the minimum inhibitory concentration (MIC) of peroxy-acids against Escherichia coli ATCC 25922. E. coli was purchased from American Type Culture Collection (ATCC). The strain was stored at −80° C. in glycerol. Prior to usage, E. coli was revived by streaking a loopful of culture onto TSAYE (i.e., tryptone soya agar yeast extract (CM0131 and LP0021; Oxoid) prepared as per recommended by Oxoid) with overnight incubation at 37° C. An overnight culture of E. coli was diluted in TSBYE (i.e, tryptone soya broth yeast extract (CM0129; Oxoid) prepared as per recommended by Oxoid) to obtain a cell suspension of ca. 10⁵ CFU/mL. Subsequently, 100 μL of the diluted culture was added to 100 μL of the test solutions at the needed concentrations into a microtiter plate (92096; TPP Techno Plastic Products AG). Peroxy-acids were tested at an active concentration of 25-1600 μg/mL. Subsequently, the inoculated plate was incubated at 37° C. up to 48 hours with the bacterial cell density recorded at optical density (OD) 600 nm at 24 hours interval using a microplate reader (Varioskan LUX; Thermo Fisher). A growth curve was constructed, and minimum inhibitory concentration (MIC) was determined as the concentration where complete inhibition (i.e., no increment in OD over 48 hours) was observed.

Results. Preliminary results showed that the MIC of peracetic and perpropionic acids are at 300 and 500 ppm (Table 7). These results demonstrated the inhibitory effect of peracetic and perpropionic acid acid against E. coli.

TABLE 7
MIC (μg/mL) against Escherichia coli ATCC 25922

| | Minimum inhibitory concentration |
|---|---|
| Sample | (μg/mL) against E. coli |
| Peracetic acid (PAA) | 300 |
| (17.5% wt. PAA, 9.8% wt. H2O2) | |
| Perpropionic acid (17.1% wt. | 500 |
| PPA, 7.8% wt. H2O2) | |

### Example 4: The Effect of Peroxy Acids in Reducing Total Enterobacteriaceae Count (TEC) in Naturally Contaminated Feed

Materials and Method. Naturally contaminated layer feed was collected, ground, and mixed well prior to weighing. The ground feed was weighed and separated into 15 different bags, each containing 300 g. TEC of each bag was determined prior to treatment, with the treatment groups as set forth in Table 8. The product/prototype was accurately weighed at the needed dosage and adjusted to a total volume of 5 mL prior to adding into the 300 g of feed with a syringe and needle. Product/prototype was added in batches (i.e., 2, 2, and 1 mL separately) and mixed after each addition. Five mL of sterile water was added into the feed and served as the control. The treated feed samples were homogenized after treatment and kept at 25° C. until the day of enumeration.

TEC of the 15 samples were studied over a period of 22 days with enumeration interval at time points 0, 1 and 22 days. The effect of peroxy acid was neutralized at each time point prior to enumeration. At each time point, 20 mL of 0.1 M sodium thiosulphate was added into 10 g of each treated feed sample in a sterile bag. The mixture was mixed well and left to stand for 10 minutes. After 10 minutes, 70 mL of BPW was added to achieve 10⁻¹ dilution. The feed suspension was homogenously mixed and left to stand for 30 minutes. Subsequently, the feed suspension was serial diluted to appropriate dilutions for enumeration. 100 uL of the diluted samples were plated onto Violet Red Bile Glucose (VRBG; CM0485 from Oxoid) agar, prepared as per recommended by the supplier. An aliquot of 0.1 mL of the feed suspension was plated onto the agar at each dilution and incubated at 37° C. for 18-24 hours prior to enumeration. Plating was carried out in triplicates. If low TEC is expected, the sample size is increased to 1 mL by plating 300, 300 and 400 uL onto three plates in triplicates for lower detection limit (10 CFU/g). The diluted feed samples (at 10⁻¹ dilution factor) were kept at 37° C. for 18-24 hours for enrichment prior to streaking. A loopful of diluted feed suspension was streaked onto the VRBG agar and incubated at 37° C. for 18-24 hours to determine qualitatively the presence of Enterobacteriaceae for samples with undetectable TEC.

Results. The researchers observed that at 5.0 and 10.0 kg/ton, peroxy acid mixture could reduce TEC up to 1 log CFU/g. Similarly, peracetic acid and Sal CURB RM E Liquid could also reduce TEC up to 1 log CFU/g, at 10.0 kg/ton and 1 kg/ton respectively. Although the results demonstrated the possible application of peroxy acid against Enterobacteriaceae, inconsistent results were observed. Such observations could be due to the inhomogeneous distribution of the Enterobacteriaceae. Additionally, the results also showed TEC reduction in the control group where no treatment is applied.

TABLE 8
TEC reduction after treatment for up to 22 days in feed

| | | | Post | Post |
|---|---|---|---|---|
| | | Pre- | treatment | treatment |
| | Dosage, | treatment | Day 1 | Day 22 |
| Sample | kg/ton | 0 | 1 | 22 |
| Control (no treatment) | — | 3.44 | 2.64 | 1.67 |
| Perpropionic acid (PPA) | 2.5 | 2.12 | 2.41 | <1.00 |
| (17.1% wt. PPA, 7.8% | 5.0 | <2.00 | 2.47 | 1.73 |
| wt. H2O2) | 10.0 | <2.00 | 2.19 | <1.00 |
| Peroxy acid mixture | 2.5 | <2.00 | 2.32 | <1.00 |
| | 5.0 | 2.22 | 1.12 | 1.48 |
| | 10.0 | 2.64 | <1.00 | <1.00 |
| Peracetic acid (PAA) | 2.5 | 3.37 | <1.00 | 3.32 |
| 17.5% wt. PAA, 9.8% wt. | 5.0 | <2.00 | 2.39 | <1.00 |
| H2O2 | 10.0 | 2.52 | 1.43 | <1.00 |
| Pro-Oxine AH | 5.0 | 2.52 | 2.37 | 1.12 |
| Sal CURB K2 Liquid | 5.0 | 2.30 | 1.85 | 3.34 |
| Sal CURB RM E Liquid | 1.0 | 2.00 | <1.00 | <1.00 |
| Sal CURB Ba Liquid | 10.0 | 2.12 | 1.75 | <1.00 |
| | 5.0 | 2.00 | 1.94 | 2.62 |

*Peroxy acid mixture is prepared with 1:1 w/w of peracetic and perpropionic acids.
Sal CURB RM E (formaldehyde product);
Sal CURB K2, Ba (non-formaldehyde product, contains organic acids);
Pro-Oxine AH (non-formaldehyde product, contains chlorine dioxide, an oxidizing agent).

### Example 5: PPA: Rapid Bactericidal Effect and its Mode of Action Against Salmonella

### Study 1: Cell Membrane Damage/Permeability Testing

Method. Cell membrane permeability was determined through crystal violet assay where an alteration in the outer cell membrane will result in a higher uptake of the dye, indicating a greater membrane permeability. An overnight culture of S. enteriditis ATCC 13076 in TSBYE was harvested with centrifugation at 6700 rcf for five minutes at room temperature using Eppendorf Centrifuge 5810 R. Upon aspirating the TSBYE, the cell pellets were washed with phosphate-buffered saline (PBS, pH 7.4, 10 mM) twice and resuspended in PBS. Subsequently, 0.75 mL of the cell suspension was added to 0.75 mL of the treatment (prepared in 10 mM PBS) into a two-milliliters microcentrifuge tube and incubated for two hours at 37° C. with agitation at 150 rpm. Cells without any treatments served as the negative control. After two hours of incubation, the cells were again harvested with centrifugation at 6700 rcf for five mins. Subsequently, the cells were resuspended in 10 μg/mL of crystal violet solution prepared in PBS and incubated for another 15 minutes with agitation at 150 rpm. After incubation, the suspension was centrifuged at 13,000 rcf for 15 minutes. The absorbance of the supernatant in each tube was measured at 590 nm. The percentage of dye uptake was calculated based on the ratio of absorbance values (Equation 1).

$$\begin{matrix}Percentage dye uptake & \\ Uptake ( \% ) = ( 1 - \frac{Abs value of supernatant}{Abs value of crystal violet solution} ) \times 100 & Equation 1\end{matrix}$$

Results. Higher dye uptake indicates higher cell permeability and thus a greater extent of cell membrane damage. PPA demonstrated the highest dye uptake (p<0.05) in comparison to the other treatments (RME and K2) at both 1 and 5 kg/T. A dose-dependent effect was also observed with PPA at 1.0, 2.5, and 5.0 kg/T, where the dye uptakes were 67.32%, 83.82%, and 88.27%, respectively. Low and negligible dye uptakes were observed in RME (37.60%, p21 0.05) and K2 (23.14%, p>0.05), respectively, at 1 kg/T, in comparison to the control (26.10%).

TABLE 9
Average dye uptake (n = 3) with different treatments.

| | Dosage | Dye uptake, |
|---|---|---|
| Sample | (kg/T) | Average ± SD (%) |
| Control | — | 26.10 ± 1.00^{a} |
| PPA* | 1 | 67.32 ± 0.80^{d} |
| PPA* | 2.5 | 83.82 ± 0.78^{e} |
| PPA* | 5 | 88.27 ± 0.42^{f} |
| Sal CURB RME Liquid | 1 | 37.60 ± 1.34^{b} |
| Sal CURB RME Liquid | 5 | 38.84 ± 0.62^{b} |
| Sal CURB K2 Liquid | 1 | 23.14 ± 2.08^{a} |
| Sal CURB K2 Liquid | 5 | 54.79 ± 0.17^{c} |

Different alphabet indicates statistically significant differences (p < 0.05).
*PPA: 17.1% wt. Perpropionic acid, 7.8% wt. Hydrogen peroxide, All treatments (Samples) were prepared in 10 mM phosphate buffer to adjust pH to ~pH 7.

### Study 2: DNA Interaction

Method (Assay 1: Treatment added to extracted DNA directly). One mL of cell suspension (ca. 10⁸ cfu/mL in TSBYE) was harvested by centrifugation at 5000 rcf for 10 minutes. The supernatant was discarded and resuspended as detailed in the protocol provided by the supplier. DNA was extracted using the QIAamp DNA Mini kit (Cat #51304, Qiagen). The samples were incubated at 56° C. for two hours and eluted with 200 uL of nuclease-free water. The same eluent was run through the column twice to increase the DNA concentration. Extracted DNA was quantified using Quant-iT dsDNA high-sensitivity assay kit (Q33120; Thermo Fischer Scientific). Extracted DNA was subsequently treated with the different treatment groups with a final concentration of 1 kg/T (prepared in 10 mM PBS). 1.5 uL of treatment solution (prepared at 10 times higher concentration) is added to 13.5 uL of extracted DNA. The solution was mixed well and left to stand at room temperature for one hour. After one hour, the solution was diluted with nuclease-free water 10 times. DNA was subsequently quantified using Quant-iT dsDNA high-sensitivity assay kit (Q33120; Thermo Fischer Scientific).
Method (Assay 2: Treatment added to cells followed by extraction). Ten mL of overnight Salmonella enteriditis ATCC 13076 culture was washed with phosphate-buffered saline (PBS, pH 7.4, 10 mM) twice and reconstitute in 10 mL PBS. 4 mL of the cell suspension was treated with 4 mL of treatment (each at 1 kg/T). The treatment solution in 10 mM PBS was prepared at twice the higher concentration prior to the addition to the cell suspension. The solution is subsequently incubated at 37° C. for two hours with shaking at 150 rpm. After two hours, centrifuge the cell suspension at 5000 rcf for 10 minutes and collect the cell pellets. Subsequently, DNA was extracted using the QIAamp DNA Mini kit (Cat #51304, Qiagen), following the protocol for gram-negative bacteria cells provided by the supplier. The samples were incubated at 56° C. for two hours and eluted with 200 uL of nuclease-free water. The same eluent was run through the column twice to increase the DNA concentration. Extracted DNA was quantified using Quant-iT dsDNA high-sensitivity assay kit (Q33120; Thermo Fischer Scientific).
Results. DNA recovered from Salmonella cells treated with PPA is the lowest at 34.97 ng/mL (Assay 2; p<0.05), indicating a greater extent of DNA damage. An opposite trend was observed where Sal CURB K2 Liquid showed the highest DNA damage with 16.3 ng/ml of DNA recovered (Assay 1; p<0.05) where treatments were added to the extracted Salmonella DNA directly. This thus confirms our hypothesis that cell membrane disruption would allow the better diffusion of actives into the intracellular space and damages the DNA to a greater extent

TABLE 10
Average DNA (n = 3) recovered from Assay 1 where treatments
were added directly to the extracted DNA, and Assay 2 where
treatments were added to Salmonella cells.

| | | DNA concentration (ng/uL), | |
|---|---|---|---|
| | Dosage | Average ± SD | |
| Sample | (kg/T) | Assay 1 | Assay 2 |
| Control | — | 55.7 ± 1.5^{c} | 68.13 ± 7.13^{b} |
| PPA* | 1 | 42.8 ± 2.9^{b} | 34.97 ± 4.54^{a} |
| Sal CURB RME Liquid | 1 | 54.0 ± 1.0^{c} | 72.73 ± 7.37^{b} |
| Sal CURB K2 Liquid | 1 | 16.3 ± 0.5^{a} | 59.73 ± 8.40^{b} |

Different alphabet indicates statistically significant difference (p < 0.05).
*PPA: 17.1% wt. Perpropionic acid, 7.8% wt. Hydrogen peroxide. All treatments (Samples) were prepared in 10 mM phosphate buffer to adjust pH to ~pH 7.

### Example 6: Corrosivity of Peroxypropionic Acid on Steel

In previous experiments, compositions containing peroxyacids were evaluated for efficacy against Salmonella in a feed assay and found to be a promising alternative to formaldehyde for the feed hygiene applications. However, there remained technical challenges related to corrosivity or the perceived risk of negative impact on the feed mill equipment due to the high corrosivity, specifically when peroxyacid would come into contact with the mild steel construction of the ribbon blender. Accordingly, the researchers sought to quantify the rate of corrosivity of the compositions of the present invention on mild steel and stainless-steel plates that are representative of equipment used in feed mills.

To demonstrate the rate of corrosivity and establish a good diluent for PPA to minimize corrosivity, mild steel and stainless steel plates were partially submerged into peroxypropionic acid solutions. These PPA solutions were prepared with different diluents to dilute (Opticurb solution) PPA concentration (5% PPA in solution) before being sprayed onto the feed. An eight-day corrosivity study at 22° C. showed that mild steel, when partially immersed in peroxypropionic acid solution with water as diluent, corroded the most with a rate of 1.517 mm/year. This rate of corrosion could be reduced by diluting PPA with 2.5 wt. % ammonium hydroxide or 5 wt. % sodium hydroxide with the rate of corrosivity found to be 0.381 mm/year and 0.337 mm/year respectively. However, the best diluent for PPA was found to be sodium phosphate buffer, which reduced the corrosivity rate to 0.2 mm/year. Subsequently, the rate of peroxy acid degradation in the diluted/Opticurb solution when in contact with mild steel was also evaluated after an hour. It was found that the PPA rate of degradation in sodium phosphate buffer was found to be minimal at ˜11% of degradation after an hour when compared to 52% and 50% when diluted with sodium hydroxide (5% wt.) and ammonium hydroxide (2.5% wt) solution respectively. Thus, the buffered peroxyacids were observed to be less corrosive compared to other diluents when interacting with mild steel.

An additional study was conducted by fully submerging the mild steel plates for 20 days in diluted/Opticurb PPA and Peroxy acetic acid (PAA) solutions with water and sodium phosphate buffer as diluents. The results showed that surprisingly the sodium phosphate buffer completely protected the mild steel plates from corrosion when in contact with PPA (0.0 mm/year). In comparison, the corrosivity was 2.9 mm/year and 2.8 mm/year when mild steel was dipped in PPA solutions diluted with water. No corrosivity issues were observed when stainless steel plates were partially or wholly immersed in PPA or PAA as-is or diluted with water, with no observed damage for as long as 6 months of monitoring.

Further, the researchers sought to quantify the rate of corrosivity when mild steel encounters PPA solutions. To demonstrate this, mild steel plates were partially submerged in peroxypropionic acid solutions made using water and other diluents such as 5% sodium hydroxide, 2.5% ammonium hydroxide, 0.1N sodium thiosulfate, and sodium phosphate buffer for certain days at 22° C. and then the plates were cleaned and recorded for their corrosivity. Based on the results, it was intended to choose a suitable diluent that could prevent the corrosivity of peroxyacid on mild steel without degrading the peroxy acid value in the solution to such an extent that it might lose the disinfecting properties in feed. Subsequently, a final study was performed to fully immerse the mild steel in the PPA with the chosen diluent and estimate the reduction in rate of corrosivity of PPA on mild steel in comparison to PPA with water as diluent.

Partially submerged corrosivity study. Peroxypropionic acid and peroxyacetic acid were prepared in-house, sodium thiosulfate 0.1N AA35645M4 and sodium hydroxide pellets S318-500 were procured from Fisher Scientific. A 25% (% wt) ammonium hydroxide solution was procured using Millipore sigma code 1054321011. Sodium hydroxide of 20 wt. % and 5 wt. % and ammonium hydroxide of 2.5 wt. % solutions were prepared. Sodium phosphate buffer was prepared by reacting 100 g of 20 wt % sodium hydroxide with 19.6 g of 75% phosphoric acid, Fisher Scientific P1481, and diluting with 217 g of water.

In a 50 ml individual plastic centrifuge tube, 8 ml of water, 2.5 wt % ammonium hydroxide, 5 wt % sodium hydroxide, 0.1N sodium thiosulfate and sodium phosphate buffer were added and to them, 2 g of PPA product produced in-house was added. To these tubes, pre-weighed mild steel plates C1018 with glass bead finish, 1/16″ thick, ½″wide and 3″ long with a 3/16″ diameter hole located from 1/14″ from an end (Metal Samples, Alabama). The tubes were initially open to allow the degradation products such as oxygen to escape. Once the effervescence stopped, the tubes were closed and monitored for 7 days at 22° C. The plates were then taken out using plastic tweezers, washed with water and dried before recording the final weight.

Fully submerged corrosivity study. Samples were stored at 22° C. for 20 days. The total volume of test solution used was 120 ml and corrosivity was calculated (Equation 2).

$$\begin{matrix}Corrosion Rate & \\ Corrosion rate ( mm / year ) = ( K \times W ) / ( A \times T \times D ) & Equation 2\end{matrix}$$

$$where : K = a constant = 8.76 \times 10 \hat{} 4 , \\ T = time of exposure in hours to the nearest 0.01 h , \\ A = area in {cm}^{2} to nearest 0.01 {cm}^{2} , W = mass loss in g , \\ to nearest 1 mg and D = density in g / cm 3 ( D mild steel = 7.87 g / cm 3 ) .$$

Stability of PPA in various diluent. In a separate study, the peroxy value of the mixture was estimated using the titrimetry procedure in 10 minutes and after 4 h of preparing the PPA solution with different diluents.

Degradation of PPA in diluted/Opticurb solutions with mild steel. In another study, the solution of PPA with different diluents was measured for the peroxyacid content initially and after 1 h of immersing the mild to test the PPA degradation rate.

The rate of corrosion of mild steel partially immersed with PPA solutions with different diluents for an eight-day study period is given in Table 11.

TABLE 11
Rate of Corrosivity of PPA solutions
on mild steel when partially immersed

| Mild | PPA | | | Corrosivity |
|---|---|---|---|---|
| Steel No | (g) | Diluent(g) | Diluent added | (mm/year) |
| C5896 | 2 | 8 | Deionized Water | 1.517 |
| C5972 | 2 | 8 | 0.1N Sodium thiosulfate | 1.110 |
| C5970 | 2 | 8 | 2.5% ammonium hydroxide | 0.381 |
| C5985 | 2 | 8 | 5% sodium hydroxide | 0.337 |
| C5974 | 2 | 8 | Sodium phosphate buffer | 0.200 |

The peroxy acid value of PPA, when diluted with different diluents, is summarized below in Table 12.

TABLE 12
Peroxyacid value of the solutions containing
PPA at different time points

| | | | | PPA composition | | | |
|---|---|---|---|---|---|---|---|
| | | | | After 10 | | After 240 | |
| | | | | minutes | | minutes | |
| PPA | Diluent | | | PPA | H₂O₂ | PPA | H₂O₂ |
| (g) | (g) | Diluent added | pH | (%) | (%) | (%) | (%) |
| 2 | 8 | Deionized Water | 1.77 | 5.54 | 1.85 | 4.75 | 1.96 |
| 2 | 8 | 2.5% ammonium | 6.11 | 4.18 | 1.85 | 3.31 | 2.34 |
| | | hydroxide | | | | | |
| 2 | 8 | 5% sodium | 5.44 | 4.4 | 1.47 | 2.55 | 1.12 |
| | | hydroxide | | | | | |
| 2 | 8 | Sodium phosphate | 5.34 | 5.82 | 1.92 | 5.19 | 1.88 |
| | | buffer | | | | | |

The rate of PPA degradation in solution when in touch with mild steel is given in Table 13.

TABLE 13
Rate of degradation of PPA solutions
when in contact with mild steel

| | | | PPA composition | | | | |
|---|---|---|---|---|---|---|---|
| | | | After 15 | | After 60 | | PPA |
| | | | minutes | | minutes | | degradation/ |
| PPA | Diluent | Diluent | PPA | H₂O₂ | PPA | H₂O₂ | min |
| (g) | (g) | added | (%) | (%) | (%) | (%) | (%) |
| 2 | 8 | Deionized | NA | NA | NA | NA | NA |
| | | Water | | | | | |
| 2 | 8 | 2.5% | 2.03 | 0.77 | 0.97 | 0.44 | 1.10 |
| | | ammonium | | | | | |
| | | hydroxide | | | | | |
| 2 | 8 | 5% sodium | 2.93 | 0.9 | 1.48 | 0.37 | 1.16 |
| | | hydroxide | | | | | |
| 2 | 8 | Sodium | 5.27 | 1.67 | 4.67 | 1.6 | 0.25 |
| | | phosphate | | | | | |
| | | buffer | | | | | |

The rate of corrosion of mild steel fully immersed with PPA and PAA solutions with water and sodium phosphate buffer as diluent for a twenty-day study period is given in Table 14.

TABLE 14
Rate of Corrosivity of PPA and PAA solutions on mild steel when fully immersed

| Mild | Peroxy | Peroxy acid | | | Corrosivity |
|---|---|---|---|---|---|
| Steel No | acid (g) | added | Diluent(g) | Diluent added | (mm/year) |
| C6399 | 0 | None | 120 | Deionized Water | 0.050 |
| C6400 | 24 | PPA | 96 | Deionized Water | 2.921 |
| C6401 | 24 | PPA | 96 | Sodium phosphate buffer | 0.000 |
| C6398 | 24 | PAA | 96 | Deionized Water | 2.825 |
| C6397 | 24 | PAA | 96 | Sodium phosphate buffer | 0.245 |

Results. The researchers have unexpectedly found a process that utilizes peroxy acid for disinfecting feed without facing corrosion issues, which is a breakthrough for the feed industry. The preliminary studies conducted to minimize the corrosivity of peroxypropionic acid on mild steel were focused on increasing the pH of PPA products to close to 4 using sodium or ammonium hydroxide. However, this approach not only decreased the peroxy value of the product significantly during the stability studies due to the salting out effect but also resulted in a violent reaction with mild steel when diluted with water as diluent. Therefore, irrespective of the PPA product's pH, it was found to react violently when in touch with mild steel, irrespective of the peroxy concentration.

The researchers have surprisingly and unexpectedly identified an alternative approach, using a new buffer diluent instead of water to overcome the technical challenged previously posed when using PPA as a component. For instance, in at least one embodiment, when PPA was diluted using several dilute bases, such as 2.5% ammonium hydroxide and sodium phosphate buffer, there appeared to be a significant inhibition in the reaction between the PPA molecule and mild steel. As noted in the results in Table 11, except 0.1N sodium thiosulfate, all other diluents were able to reduce the PPA's corrosivity on mild steel significantly. However, the researchers further considered whether the peroxy concentration would remain intact at the time of application. Therefore, the peroxy value of PPA with various diluents was measured as shown in Table 12. It was observed that PPA molecule was more stable with sodium phosphate buffer than with diluted sodium hydroxide or ammonium hydroxide. The opticurb concentration (PPA diluted in the diluent(s)) was recorded at two different time points while a mild steel plate was dipped in the solution to confirm this observation further. These results are tabulated in Table 13. It can be found that the peroxy acid value degraded faster in solutions containing ammonium and sodium hydroxide than in sodium phosphate buffer. This further probed to form a hypothesis that the phosphate could form a temporary complex with peroxy acid function group/molecule thereby preventing its violent interaction with mild steel and avoiding the rapid decrease in peroxy concentration. To further prove this hypothesis, the mild steel plates were dipped completely in both PAA and PPA solutions containing sodium phosphate buffer compared to water.

The results (FIG. 4) showed that the PPA molecule did not cause even slight corrosion on mild steel when dipped in sodium phosphate buffer.

Surprisingly and unexpectedly, the portion of the two plates submerged in the liquid containing PPA did not show any corrosion. This new development using phosphate buffer as peroxyacid diluent/Opticurb (before spraying on feed) to prevent aggressive corrosion of mild steel would open a new window for feed industries and allow a safer handling/use of the peroxy acid formulations of the present invention, including as a formaldehyde-free antimicrobial ingredient for animal feed. The peroxyacid compositions of the present invention are promising alternatives to formaldehyde in contrast to commercially available organic acids blends and acidified sodium chlorite/chlorine dioxide.

### Example 7: The Synergistic Effects of Organic Acids i.e., Acetic and Citric Acid to PPA

The researchers investigated adding other organic acids to peroxypropionic acid (PPA, a mixture containing 27% wt. Perpropionic acid, 9% wt. H₂O₂, ˜30-35% propionic acid and water) to determine if they could further improve its broad-spectrum antimicrobial efficacy. Therefore, several prototypes were prepared where organic acids such as lactic acid, citric acid, acetic acid, and formic acid were individually added to PPA at different ratios and studied for the stability of the overall peroxyacid content, which is critical for the molecule's antimicrobial efficacy. Eventually, acetic acid and anhydrous citric acid were found to be the most compatible with PPA in preserving the peroxyacid value compared to other acids. Therefore, further studies were carried out to better understand the synergistic effects of acetic and citric acid to PPA as shown in (Table 15).

Results. The study showed that T19 gave the least Salmonella count at a significantly lower treatment dose when applied onto the feed matrix at 2.5 Kg/T. This formulation is a synergistic mixture of PPA equilibrium mixture ˜85%, 14.8% acetic acid and 1.2% citric acid. Interestingly, when compared to T1, which is ˜77% PPA and ˜23% acetic acid, the formulation required 3.9 Kg/T dosage to reduce similar Salmonella count. The study showed the importance of adding a small amount of citric acid in the formulation for better efficacy.

TABLE 15
The synergistic effects of organic acids i.e., glacial acetic acid (AA, 100% wt.) and citric acid (CA, 100% wt.) to
Perpropionic acid or PPA (PPA, a mixture containing 27% wt. Perpropionic acid and 9% wt. H₂O₂, ~30-35% propionic
acid and water). All treatments (formulation) were prepared in phosphate buffer to adjust pH in a range of pH 10-12.

| | | | Diluent | |
|---|---|---|---|---|
| | | | mix with | |
| | | | phosphate | Salmonella |
| Treatment | | | buffer to | count range |
| groups | Formula | Product | pH ~10-11 | (Log CFU/g) |

| | | | | | | | | | |
|---|---|---|---|---|---|---|---|---|---|
| PPA | AA | CA | Dose | Buffer | Set 1 | Set 2 | Set 3 | Total | Average |
| (%) | (%) | (%) | (Kg/T) | Kg/T | (N = 3) | (N = 3) | (N = 3) | count | count |

| | | | | | | | | | | | | | | | | |
|---|---|---|---|---|---|---|---|---|---|---|---|---|---|---|---|---|
| NC | 0 | 0 | 0 | 0 | 0 | 510 | 380 | 300 | 120 | 140 | 460 | 150 | 20 | 50 | 2130 | 236.7 |
| NC + | 0 | 0 | 0 | 0 | 20 | 1190 | 130 | 150 | 130 | 40 | 130 | 70 | 170 | 70 | 2080 | 231.1 |
| Buffer | | | | | | | | | | | | | | | | |
| T1 | 100 | 30 | 2.5 | 3.975 | 16.025 | 10 | 10 | 10 | 20 | 0 | 40 | 0 | 30 | 0 | 120 | 13.3 |
| T2 | 100 | 30 | 0 | 3.9 | 16.1 | 20 | 10 | 10 | 10 | 0 | 0 | 10 | 10 | 10 | 80 | 8.9 |
| T3 | 100 | 15 | 1.25 | 3.48 | 16.52 | 0 | 30 | 40 | 10 | 10 | 10 | 10 | 0 | 0 | 110 | 12.2 |
| T4 | 100 | 0 | 2.5 | 3.075 | 16.925 | 40 | 10 | 0 | 0 | 10 | 70 | 20 | 10 | 10 | 170 | 18.9 |
| T5 | 100 | 0 | 0 | 3 | 17 | 30 | 0 | 60 | 0 | 0 | 0 | 10 | 50 | 0 | 150 | 16.7 |
| T6 | 90 | 7.5 | 2.5 | 3 | 17 | 40 | 900 | 50 | 50 | 90 | 120 | 0 | 10 | 40 | 1300 | 144.4 |
| T7 | 90 | 10 | 0 | 3 | 17 | 10 | 0 | 10 | 70 | 30 | 30 | 20 | 20 | 10 | 200 | 22.2 |
| T8 | 85 | 30 | 1.25 | 3.48 | 16.52 | 0 | 30 | 70 | 0 | 10 | 20 | 20 | 10 | 40 | 200 | 22.2 |
| T9 | 85 | 15 | 2.5 | 3.075 | 16.925 | 10 | 0 | 10 | 40 | 0 | 0 | 40 | 30 | 210 | 340 | 37.8 |
| T10 | 85 | 15 | 1.25 | 3.037 | 16.963 | 30 | 20 | 10 | 20 | 60 | 40 | 20 | 10 | 20 | 230 | 25.6 |
| T11 | 85 | 12.5 | 2.5 | 3 | 17 | 40 | 50 | 40 | 40 | 10 | 10 | 0 | 30 | 40 | 260 | 28.9 |
| T12 | 85 | 15 | 0 | 3 | 17 | 20 | 70 | 10 | 0 | 50 | 0 | 0 | 40 | 30 | 220 | 24.4 |
| T13 | 85 | 0 | 1.25 | 2.587 | 17.413 | 50 | 250 | 0 | 0 | 10 | 10 | 0 | 20 | 0 | 340 | 37.8 |
| T14 | 80 | 17.5 | 2.5 | 3 | 17 | 60 | 30 | 80 | 0 | 0 | 0 | 10 | 50 | 0 | 230 | 25.6 |
| T15 | 80 | 20 | 0 | 3 | 17 | 60 | 0 | 20 | 0 | 30 | 0 | 10 | 0 | 0 | 120 | 13.3 |
| T16 | 75 | 22.5 | 2.5 | 3 | 17 | 70 | 10 | 70 | 20 | 40 | 70 | 0 | 10 | 10 | 300 | 33.3 |
| T17 | 70 | 30 | 2.5 | 3.075 | 16.925 | 10 | 0 | 20 | 0 | 10 | 10 | 120 | 0 | 0 | 170 | 18.9 |
| T18 | 70 | 27.5 | 2.5 | 3 | 17 | 0 | 10 | 130 | 80 | 20 | 70 | 40 | 70 | 0 | 420 | 46.7 |
| T19 | 70 | 15 | 1.25 | 2.587 | 17.413 | 0 | 10 | 40 | 30 | 0 | 0 | 0 | 10 | 0 | 90 | 10.0 |
| T20 | 70 | 0 | 2.5 | 2.175 | 17.825 | 50 | 90 | 140 | 0 | 0 | 10 | 0 | 10 | 10 | 310 | 34.4 |
| T21 | 70 | 0 | 0 | 2.1 | 17.9 | 140 | 50 | 270 | 20 | 30 | 0 | 10 | 30 | 110 | 660 | 73.3 |

| T22 | One pot | 3 | 17 | 0 | 60 | 10 | 10 | 10 | 20 | 0 | 10 | 0 | 120 | 13.3 |
|---|---|---|---|---|---|---|---|---|---|---|---|---|---|---|
| | Synthesis | | | | | | | | | | | | | |

### Example 8: The Synergistic Effects of Organic Acids i.e., Acetic to PPA

Method: Preparation of PPA mixtures, PPA, and acetic acid solution. A total of three PPA mixtures, namely MIX 90, MIX 80, and MIX 70, were prepared with a PPA base containing 18.5% PPA and 10.0% hydrogen peroxide, and acetic acid (102436136, Sigma-Aldrich) (Table 16). MIX 90 was prepared by adding 1.0 g acetic acid to 9.0 of PPA of 18.5% wt. purity (solution contains 18.5% wt.PPA, ˜7% H2O2, ˜45% propionic acid and aqueous solution). The mixture was vortexed to mix well and left to stand overnight (18 hours) at room temperature before use. A similar procedure was followed in the preparation of MIX 80 and 70. Acetic acid and PPA solutions were also prepared at the same concentrations with water for comparison.

TABLE 16
Compositions of the PPA mixture, PPA, and acetic acid solutions.

| | PPA | Acetic | | |
|---|---|---|---|---|
| | base | acid | | Citric acid |
| Treatment | (%) | (%) | Water (%) | (%) |
| PPA 100 | 100.0 | — | — | — |
| PPA 90 | 90.0 | — | 10.0 | — |
| PPA 80 | 80.0 | — | 20.0 | — |
| PPA 70 | 70.0 | — | 30.0 | — |
| MIX 90 | 90.0 | 10.0 | — | — |
| MIX 80 | 80.0 | 20.0 | — | — |
| MIX 70 | 70.0 | 30.0 | — | — |
| Acetic acid 10 | — | 10.0 | 90.0 | — |
| Acetic acid 20 | — | 20.0 | 80.0 | — |
| Acetic acid 30 | — | 30.0 | 70.0 | — |

Method In feed study: Efficacy evaluation of PPA samples in feed. 500 g of corn-soy diet feed, procured from Des Moines Feed, was sterilized by autoclaving at 121° C. for one hour in a 1000 mL beaker and subsequently dried at 65° C. for 24 hours before use. An overnight culture of Salmonella enteriditis ATCC 13076 was prepared by inoculating a single colony into 10 mL of TSB and incubated at 37° C. (211DS; Labnet) for 18-24 hours. After incubation, the overnight culture was diluted ten-fold to a concentration of ca. 107 CFU/mL before use. Two grams of sterilized feed were weighed into a 50 mL sterile conical tube. 20 μL of the diluted Salmonella culture was subsequently added to the feed to achieve a contamination level of ca. 105 CFU/g. The contaminated feed sample was mixed well and left to stand for 15 minutes before treatments. Different treatments were added to the contaminated feed at the stated dosages (Table 17). Each treatment was carried out in triplicates. Considering that different volumes of treatments are required at different dosages, the treatment was accurately weighed at the needed dosage and adjusted to a total volume of 40 μL. Briefly, to achieve 3.0 kg/T of treatment, 6 mg (equivalent to approximately 6 μL) of treatment solution was mixed with 34 mg (equivalent to 34 μL) of ultrapure water before the addition to 2.0 g of contaminated feed. On the other hand, to achieve 3.5 kg/T, 7 mg (equivalent to approximately 7 μL) of treatment solution was mixed with 33 mg (equivalent to 33 μL) of ultrapure water before addition to the feed. The treatment solution was added to the feed immediately and mixed well. The treated feed samples were left to stand for an hour at room temperature before plating. After one hour, the efficacy in eliminating or killing Salmonella was determined via conventional plating for each treatment. 18 mL of buffered peptone water (BPW; CM0509, Thermo Fischer Scientific; prepared as per supplier's recommendation where 8 g of BPW powder is added into 400 mL of ultrapure water and autoclave at 121° C. for 15 minutes) was added to the 2 g of feed for enumeration. This is the 10-1 dilution sample. Conventional plate counting was carried out by further diluting the samples ten-fold to an appropriate dilution (10-4 dilution) with BPW as diluent and aliquoting 1 mL of the diluted samples onto the 3MTM Petrifilm® Enterobacteriaceae count plates. Subsequently, the plates were incubated at 37° C. for 18-24 hours before counting. The plate count for each sample was carried out in triplicates.

TABLE 17
Treatments and the dosages used in the screening.

| Treatment | Dosage |
|---|---|
| (Abbreviation) | (kg/T) |
| PPA 100 | 3.5 |
| | 3.0 |
| PPA 90 | 3.0 |
| PPA 80 | 3.0 |
| PPA 70 | 3.0 |
| MIX 90 | 3.0 |
| MIX 80 | 3.0 |
| MIX 70 | 3.0 |
| Acetic acid | 3.0 |
| 10 (AA 10) | |
| Acetic acid | 3.0 |
| 20 (AA 20) | |
| Acetic acid | 3.0 |
| 30 (AA 30) | |

Result: Efficacy evaluation of PPA samples in feed. No significant Salmonella reduction was observed with all acetic acid treatments, containing 10, 20, and 30% of acetic acid in water (FIG. 5) as compared to the control. However, when applied in combination with the PPA base, the efficacy of the mixtures (MIX 70, 80, and 90) was comparable to that of the PPA base (PPA 100). In combination, the acetic acid present may enhance the antimicrobial effect. The mixtures (MIX 70, 80, and 90) showed comparable Salmonella reduction of 1-2 log (CFU/g) as compared to their respective PPA base (PPA 70, 80, and 90). Comparable Salmonella reduction was observed between PPA 100 (PPA base of 18.5%) at 3.0 and 3.5 kg/T. No Salmonella was detected in the blank feed (i.e., untreated sterile feed) upon enrichment for 18-24 hours.

### Example 9: The Peroxypropionic Acid Efficacy Against Salmonella in Swine Feed

Swine mash feed contains a bigger particle size of corn-soy matrix compared to broiler mash feed. Thus, it could pose a challenge to expect the same antimicrobial efficacy as observed in broiler feed due to the shielding effect. Therefore, to maximize the efficacy of the peroxypropionic acid on the swine feed, an optimal droplet size of the peroxypropionic acid was required to ensure maximum distribution of the product onto the feed. Swine mash feed of 25 g was taken in five individual bags and inoculated with 10 mg cocktail of four freeze-dried salmonella strains of Salmonella typhimurium ATCC 14028, Salmonella senftenberg ATCC 43485, Salmonella montevideo ATCC 8387, and Salmonella enteritidis ATCC 13076 in such a way that the total infection in the feed was ˜2 logs. Then, the feed samples were treated with peroxypropionic acid solution (˜17% PPA, 7% H₂O₂) and sodium phosphate buffer premix (9:1 ratio) at 1.5 kg/T, 3 Kg/T, and 6 Kg/T. The feed was enumerated completely for Salmonella count using EB plates at 4 h after treatment. The results are tabulated in Table 18. Two untreated controls, NC-A and NC-B were kept as negative controls to represent the infection in the feed.

TABLE 18
Salmonella count in swine feed after 4h of treatment
with Peroxy propionic acid and buffer

| | | | | | | | Average | |
|---|---|---|---|---|---|---|---|---|
| | Total counts in CFU | | | | | Total | CFU/g | Log |
| Groups | at 4 h (n = 5) | | | | | CFU | feed | CFU/g |
| Negative | 90 | 40 | 190 | 90 | 210 | 620 | 124 | 2.09 |
| Control -A | | | | | | | | |
| Negative | 80 | 230 | 370 | 260 | 160 | 1100 | 220 | 2.34 |
| Control -B | | | | | | | | |
| PPA 1.5 | 20 | 10 | 50 | 10 | 0 | 90 | 18 | 1.26 |
| Kg/T | | | | | | | | |
| PPA 3 Kg/T | 0 | 0 | 0 | 0 | 0 | 0 | 0 | 0.00 |
| PPA 6 Kg/T | 0 | 0 | 0 | 0 | 0 | 0 | 0 | 0.00 |

All treatments (Samples) were prepared by mixing PPA with sodium phosphate buffer (9:1), resulting in a solution at ~pH 7-8.

### Example 10: The Peroxypropionic Acid Efficacy Against Salmonella in Broiler Feed and its Recontamination Effect

The broiler corn soy mash feed of 1200 g was taken in a gallon ziplock bag and to it 16 g of E+06 CFU/g freeze dried Salmonella cocktail was added to produce a mix containing E+04 CFU/g of Salmonella. The feed was split into 12 bags of 100 g each to analyze four treatment groups in triplicate. Feed was inoculated on day zero and reinoculated on days 7, 14 and 21. Each inoculation or reinoculation was calculated to deliver E+04 CFU Salmonella/g feed. After inoculating feed with the FDA-specified Salmonella mix on day 0, peroxypropionic acid (150,000 mg/L or 150 mg/mL) was applied with a calibrated pipette at 0.66, 1.33 and 2.00 mL per 100 g of feed to achieve 1.0, 2.0 and 3.0 mg PPA (equilibrium mixture contains 16% wt. PPA, 23% wt. H2O2)/g of feed respectively. Each treatment replicate (n=3) was individually treated. Ziploc bags were quickly sealed, and the contents were vigorously shaken to evenly distribute the treatments. Samples were stored at room temperature for the duration of the study. The results are shown in (FIGS. 6-9).

### Example 11: The Nutrient Impact of Peroxypropionic Acid with Sodium Phosphate Buffer on Commercial Broiler Feed Formulation

The researchers next considered whether peroxypropionic acid, when premixed with sodium phosphate buffer before applying to the feed, would have a detrimental impact on feed ingredients when compared with the untreated control group (C). The prototype of the peroxypropionic acid solution (17% PPA, 7% H2O2) was mixed with sodium phosphate buffer (pH 12) at an 8:2 ratio and applied at 1.25, 3.75, and 7.5 Kg/T (T1-T3, respectively). The feed formulation is shown in Table 19 for a 50 Kg batch. The nutrient specification is shown in Table 20. The feed was determined for proximate analysis, lysine, vitamin E, peroxide value, and rancidity of the oil extracted from the feed.

TABLE 19
Commercial broiler finisher feed formulation

| Composition | Kg |
|---|---|
| Maize | 32.490 |
| Soya (45%) | 10.697 |
| Rice Polish | 1.000 |
| Mustard oil cake | 1.500 |
| Meat Bone meal (43.5%) | 1.500 |
| De-oiled rice bran | 0.500 |
| Crude Rice bran Oil | 1.450 |
| Dicalcium phosphate | 0.050 |
| Calcite | 0.160 |
| DL-Methionine | 0.100 |
| L-Lysine | 0.105 |
| Salt | 0.115 |
| Soda | 0.065 |
| Toxin Binder | 0.050 |
| L-Threonine | 0.025 |
| Vitamins | 0.025 |
| Choline Chloride (60%) | 0.050 |
| Acidifier | 0.050 |
| Anticoccidial | 0.025 |
| Probiotic | 0.010 |
| Trace Mineral | 0.025 |
| Antioxidant | 0.005 |
| Phytase | 0.005 |
| Total | 50.000 |

TABLE 20
Nutrient Specifications for the feed formulation

| | |
|---|---|
| Crude Protein (%) | 18 |
| Energy (Kcal/Kg) | 3600 |
| Digestible Lysine (%) | 0.95 |
| Calcium % | 0.73 |
| Available Phosphorous (%) | 0.41 |
| Sodium (%) | 0.17 |
| Chloride (%) | 0.23 |
| Crude Fibre (%) | 3.5 |
| Ether Extract (%) | 6.2 |
| Na+K—Cl (meq/l) | 202 |

TABLE 21

| | | Crude | Crude | | | Peroxide | |
|---|---|---|---|---|---|---|---|
| | Energy | protein | fat | Lysine | Vit E | Value | |
| Group | (KCal/kg) | (%) | (%) | (%) | (mg/100 g) | (meq/kg) | Rancidity |
| C | 3612 | 18.94 | 6.6 | 0.76 | 3.07 | <0.1 | Absent |
| T1 | 3611 | 18.73 | 6.5 | 0.73 | 3.31 | <0.1 | Absent |
| T2 | 3593 | 18.54 | 6.5 | 0.83 | 3.14 | <0.1 | Absent |
| T3 | 3600 | 18.20 | 6.6 | 0.88 | 3.06 | <0.1 | Absent |

Results. The researchers observed no or minimal impact on feed quality after treatment with PPA in the presence of phosphate buffer of all the treatment groups, with no detected rancidity, as summarized Table 21.

As described herein, the inventors have surprisingly identified an alternative to conventional antimicrobials for animal feed that contain formaldehyde, where the present invention relates to antimicrobial compositions containing one or more peroxy acid that are a suitable, and less corrosive than commercially-available compositions, for controlling pathogen growth in animal feed. According to one aspect of the present invention, the composition is a formaldehyde-free feed additive that can reduce or eliminate pathogen growth, such as Salmonella, in animal feed. The benefits of the compositions of the present invention have been confirmed by its performance when compared against the organic acids blends and acidified sodium chlorite/chlorine dioxide described herein.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

### REFERENCES

1. Bauermeister, L.J., Bowers, J.W.J., Townsend, J.C., McKee, S.R. (2008). The Microbial and quality properties of poultry carcasses treated with peracetic acid as an antimicrobial treatment. Poultry Science. Vol 87, Issue 11
2. Kitis, M. (2004). Disinfection of wastewater with peracetic acid: a review. Environment International. Vol 30, Issue 1, 47-55
3. Stearns, R., Freshour, A., Shen, C. (2022). Literature review for applying peroxyacetic acid and/or hydrogen peroxide to control foodborne pathogens on food products. Journal of Agriculture and Food Research. Vol 10
4. Higgins C., Brinkhaus F. (1999). Efficacy of several organic acids against molds. The Journal of Applied Poultry Research, 8:480-487.
5. Jackman JA, Boyd RD, Elrod CC (2020) Medium-chain fatty acids and monoglycerides as feed additives for pig production: towards gut health improvement and feed pathogen mitigation. Journal of Animal Science and Biotechnology, 11(44)
6. Gomez-Osorio LM, Yepes-Medina V, Ballou A, Parini M, Angel R (2021). Short and Medium Chain Fatty Acids and Their Derivatives as a Natural Strategy in the Control of Necrotic Enteritis and Microbial Homeostasis in Broiler Chickens. Frontiers in Veterinary Science, 8:773372.
7. Skrivanová E, Savka OG, Marounek M (2004) In vitro effect of C2-C18 fatty acids on Salmonellas. Folia Microbiol (Praha), 49(2):199-202.
8. Skřivanová E, Marounek M, Dlouhá G, Kaňka, J (2005). Susceptibility of Clostridium perfringens to C2-C18 fatty acids. Letters in Applied Microbiology, 41:77-81.
9. Marounek M, Skrivanová E, Rada V (2003) Susceptibility of Escherichia coli to C2-C18 fatty acids. Folia Microbiol (Praha), 48(6):731-5.
10. Batovska D, Todorova I, Tsvetkova I, Najdenski, H (2009). Antibacterial Study of the Medium Chain Fatty Acids and Their 1-Monoglycerides: Individual Effects and Synergistic Relationships. Polish journal of microbiology/Polskie Towarzystwo Mikrobiologów=The Polish Society of Microbiologists, 58(1):43-7.
11. Cochrane RA, Dritz SS, Woodworth JC, Stark CR, Saensukjaroenphon M, Gebhardt JT, Bai JF, Hesse RA, Poulsen EG, Chen Q Gauger PC, Derscheid RJ, Zhang J, Tokach MD, Main RG, Jones CK (2020) Assessing the effects of medium-chain fatty acids and fat sources on PEDV infectivity, Translational Animal Science, 4(2):1051-1059.
12. Tran HTT, Truong AD, Ly DV, Hoang TV, Chu NT, Nguyen HT, Dang ATK, De Vos M, Lannoo K, Bruggeman G, Dang HV (2021) The potential anti-African swine fever virus effects of medium chain fatty acids on in vitro feed model: An evaluation study using epidemic ASFV strain circulating in Vietnam. Open Vet J, 11(3):346-355.

1. An animal feed additive comprising one or more peroxyacid in an amount effective to reduce Salmonella present in the animal feed to less than detection level within 24 hours, wherein the peroxyacid is selected from the group consisting of C1 to C10 alkyl chains and wherein the composition does not contain formaldehyde.

2. The feed additive of claim 1, wherein the additive comprises two or more peroxyacid selected from the group consisting of propionic acid, peracetic acid, peroctanoic acid, and perdecanoic acid.

3. The feed additive of claim 1, wherein the additive comprises a combination of two or more peroxyacid selected from the group consisting of propionic acid, peracetic acid, peroctanoic acid, and perdecanoic acid.

4. The feed additive of claim 1, wherein the feed additive is a buffered peroxyacid composition that is effective at a pH ranging from about 1 to 12, specifically about 1 to 6, about 7 to 8, about 8 to 10, or about 11 to 12.

5. The feed additive of claim 4, wherein the buffered peroxyacid composition contains mono, di, sodium phosphate, and or trisodium phosphate, ammonium phosphate, sodium hydroxide, or ammonium hydroxide.

6. The feed additive of claim 1, wherein the additive further comprises one or more esters.

7. A method of controlling the growth of pathogens in animal feed comprising adding a buffered peroxyacid composition to animal feed in an amount effective to reduce the presence of the pathogen, wherein the composition does not contain formaldehyde and the composition has a pH of about 7 to 12.

8. The method of claim 7, wherein the one or more peroxyacid is selected from the group consisting of C1 to C10 alkyl chains.

9. The method of claim 7, wherein the composition contains a combination of two or more peroxyacid selected from the group consisting of propionic acid, peracetic acid, peroctanoic acid, and perdecanoic acid.

10. The method of claim 7, wherein the composition further comprises one or more esters.

11. The method of claim 7, wherein the pH of the composition was adjusted by adding a buffer selected from the group consisting of sodium phosphate, sodium hydroxide, and ammonium hydroxide.

12. The method of claim 7, wherein the buffer is sodium phosphate.

13. The method of claim 7, wherein the buffered solution is less corrosive to steel than the non-buffered peroxyacid composition.

14. A method of reducing the amount of Salmonella present in the animal feed to less than detection level comprising:
(a) preparing a peroxyacid composition comprising one or more peroxyacids;
(b) preparing a buffered peroxyacid composition by adjusting the pH of the peroxyacid composition to about 7 to 12; and
(c) applying the buffered peroxyacid composition to animal feed.

15. The method of claim 14, wherein the buffered peroxyacid composition does not contain formaldehyde.

16. The method of claim 14, wherein the one or more peroxyacid is selected from the group consisting of C1 to C10 alkyl chains.

17. The method of claim 14, wherein the one or more peroxyacids are selected from the group consisting of propionic acid, peracetic acid, peroctanoic acid, and perdecanoic acid, and wherein the composition does not contain formaldehyde.

18. The method of claim 14, wherein the composition further comprises one or more esters.

19. The method of claim 14, wherein the buffered peroxyacid composition is prepared using a buffer selected from the group consisting of sodium phosphate, sodium hydroxide, and ammonium hydroxide.

20. The method of claim 14, wherein the buffered peroxyacid composition is less corrosive to steel than the non-buffered peroxyacid composition.
